(19) United States
(12) Patent Application Publication
(10) Pub. No.: US 2021/0379878 A1
(43) Pub. Date: Dec. 9, 2021

(54) FLAT BED APPLICATOR ARRANGEMENT AND A METHOD FOR USE OF A FLAT BED APPLICATOR ARRANGEMENT

(71) Applicant: CWT WORKTOOLS AB, KIL (SE)

(72) Inventor: Patrik Johansson, Karlstad (SE)

(21) Appl. No.: 17/286,552

(22) PCT Filed: Sep. 17, 2019
(86) PCT No.: PCT/EP2019/074862

§ 371 Date: Apr. 19, 2021

(30) Foreign Application Priority Data
Oct. 17, 2018 (SE) 1851274-9

(51) Int. Cl. B32B 37/00; B32B 37/10; B25H 1/02; B25H 1/16

(52) U.S. Cl. CPC B32B 37/0053; B25H 1/16; B25H 1/02; B32B 37/10

(57) ABSTRACT

The invention relates to a method for and a flatbed applicator, comprising a table (2) and a roll (1) movably guided vertically and horizontally along the table (2) by means of post members (3), a horizontal guiding structure comprising fixed parallel profiles (40) attached to the table (2) and guide members (41) fixedly attached to a support structure (4) carrying each of said post members (3), each of said post members (3) including a vertically moveable support structure (34) and a vertical guiding arrangement (30) arranged to guide said vertically moveable support structure (34), a power unit (5) and transmission (6A, 6B, 7) arranged to enable vertical movement of said vertically moveable support structure (34), said roll (1) comprises shaft ends (10A, 10C) that are connected to said vertically moveable support structure (34), wherein, said power unit (5) is in the form of a motor attached to said support structure (4) and arranged under said table (2) that said transmission (6A, 6B, 7) is in the form of a single reduction gear mechanism (7) attached to said transversal support member (42) and that said single reduction gear mechanism (7) is arranged to synchronously transmit torque to one or a pair of drive shaft (6A, 6B), which via a mechanical transmission (31, 33) drives said vertically movable support structure (34).

### TECHNICAL FIELD

The present invention relates to a flatbed applicator, comprising a table and a roll movably guided vertically and horizontally along the table by means of post members, a horizontal guiding structure comprising fixed parallel profiles attached to the side edges of the table and guide members fixedly attached to a support structure carrying each of said post members,

each of said post members including a vertically moveable support structure and a vertical guiding arrangement arranged to guide said vertically moveable support structure and a power unit and actuator arranged to enable vertical movement of said vertically moveable support structure,

said roll comprising shaft ends that are connected to said vertically moveable support structure.

### BACKGROUND ART

From WO9853987 there is known a flatbed applicator using a traverse spanning the laying-out surface, which is passed in controlled manner over the laminating table, wherein a rotatable press roll arranged on said traverse, is applied under pressure to produce a desired laminate, wherein the flat bed applicator comprises a traverse spanning the laying-out surface, having linearly movable guided post comprising control and journaling means. However, such a design is both costly and complex, especially due to the use of a bulky traverse device.

From DE DE202010011881 there is known a flatbed applicator wherein the traverse device has been eliminated by means of separating the axis of the press roll from the actual roll and securing a shaft coaxial with the axis to the post members. However, the design suffers from insufficiencies regarding the need of synchronized control and the need of stable and precise control of the movement of the press roll.

### SUMMARY OF THE INVENTION

According to one aspect of the present invention, one object of the invention is to provide an improved flatbed applicator without any traverse device, which is achieved with a flatbed applicator arrangement according to claim 1.

Thanks to the invention a very cost-effective design is provided which may also provide many other advantages, e.g.;
extreme ease of use,
easy pressure control when laminating is performed,
significant advantages during installation because the final machine assembly may easily be performed in-situ
significant flexibility and easy maintenance,
low weight etc.

Further preferred aspects of the invention may be that;
said mechanical transmissions include a pinion and a dented rack, which provides the advantage that a precise vertical movement may be achieved and that the roll with the vertically movable support structure may be easily taken out of the post.
said single reduction gear mechanism has a reduction rate in the range of 1/30-1/100 and that said pinion has an outer diameter in the range of 20-35 mm, preferably 25-30 mm and a pitch in the range of 3-7 mm, preferably 4-6 mm, which provides the advantage that a comfortable noise level is achieved in combination with a sufficient supply of power and also an optimal speed for the movement of the roll.
said vertically moveable support structure includes a resilient arrangement comprising a support member, a roll member and a resilient member arranged to transfer load between said support member and said roll member, which provides the advantage that a resilient pressure application may be achieved when applying the roll onto an object to be laminated.
a lower part of said vertically moveable support structure includes a dented rod, forming one of the parts of said mechanical transmission, which dented rod has an upper part attached, preferably adjustably, to a bottom part of said support member, which provides the advantage that a compact a reliable mechanism is achieved to apply a resilient pressure.
said lower rack part includes from said bottom part upwardly protruding wall parts that protrude past the resilient member and at the top a top part forming an upper stop for an upper end of said resilient member, and that said roll member includes an upper part comprising a roll attachment for fixation of said roll shaft end and downwardly protruding wall parts protruding past said resilient member and at the bottom a bottom part forming a lower stop for the lower end of said resilient member, which provides the advantage that a very compact and reliable mechanism is achieved to apply a resilient pressure
said resilient arrangement includes transversal guide members interacting with vertical slits arranged to safeguard a substantially rectilinear vertical movement relative to each other of said support member and said roll member, wherein preferably said vertical slits define a limited range of relative movement between said support member and said roll member, which provides the advantage that the cost effective mechanism may be achieved.
said resilient member is positioned between said two stop parts in a pretensioned manner urging said support member and said roll member to be positioned at a maximum distance apart in unloaded mode, wherein preferably said pretension is adjustable, more preferred by adjustment of the attachment point of said upper part and said bottom part of said support member, which provides the advantage that a compression spring may be used that provides extra compactness thanks to being compressed under activation.
the guiding arrangement on each side is arranged with a pair of guide units, wherein each unit comprises two horizontally off set guide members, arranged to enable an adjustable clamping pressure within said profile, which provides a cost-efficient solution of the guiding arrangement.
said flatbed applicator table is supported by a leg arrangement having remotely adjustable feet, preferably attached to each end of a pair of transversally extending feet beams, which provides the advantage that the height of the table may easily and quickly be adjusted to any desired height within the limits of the actuator.
said feet comprises a bottom portion, preferably U-shaped, having parallel substantially vertical leg sides joined by a horizontal top plate enclosing a motor and reduction gear of a linear actuator, wherein an opening in said horizontal top plate forms passage for the threaded part of said linear actuator and that a vertical support structure is arranged on top of said horizontal top plate, which vertical support structure is arranged to support and guide a vertically movable feet arrangement attachment device, which provides the advantage that the motors and gear mechanism may be hidden, and the linear actuator may be provided in an efficient manner and also esthetically.
said vertical support structure comprises two parallel vertical plates and that said vertically movable feet arrangement attachment device comprises two horizontal support plates are arranged in-between said two parallel vertical plates having coaxial through holes for said threaded part, which provides the advantage reliable and secure guiding may be achieved during height adjustment.

Further advantages may become apparent from the detailed description below.

### BRIEF DESCRIPTION OF THE FIGURES

In the following the invention will be described more in detail with reference to the enclosed figures, wherein:

FIG. 1 shows a perspective view from above of a flatbed applicator according to a first embodiment of the invention,

FIG. 2 is a side view of the embodiment in FIG. 1,

FIG. 3 is a detailed side view of a chosen part of a preferred embodiment of the invention including the vertically moveable support structure,

FIG. 4 is a detailed view of the vertically moveable support structure,

FIG. 5 is a perspective view from above of an adjustable foot according to a preferred embodiment of the invention, and,

FIG. 6 is a side view of the foot in FIG. 6.

FIG. 7 is a transversal cross-sectional view of a modified embodiment of a flatbed applicator according to a preferred embodiment of the invention,

FIG. 8 is a longitudinal cross-sectional view of a modified embodiment of a post member according to a preferred embodiment of the invention,

FIG. 9 is a detailed view of a modified embodiment of the vertically moveable support structure shown in FIG. 8,

FIG. 10 is a longitudinal cross-sectional view of the modified embodiment of a flatbed applicator according to the preferred embodiment of the invention, wherein the post is in a vertical active position,

FIG. 11 is a longitudinal cross-sectional view of the modified embodiment of a flatbed applicator according to the preferred embodiment of the invention, wherein the post is in a pivoted horizontal non-active position,

FIG. 12 is a perspective view of a preferred frame structure of a flatbed applicator according to the preferred embodiment of the invention,

FIG. 13 is a transversal cross-sectional view of the preferred frame structure along V111-V111 in FIG. 12,

FIG. 14 is a detailed view of the encircled area A in FIG. 13,

FIG. 15 is a perspective view of a longitudinal frame member of the preferred frame structure,

FIG. 16 is a perspective view of a tranversal frame member of the preferred frame structure,

FIG. 17 is a perspective view of a third frame member of the preferred frame structure, and,

FIG. 18 is a side view of an additional design feature of a flatbed applicator according to the preferred embodiment of the invention, wherein the table is pivotally arranged and pivoted to a substantially vertical position.

### DETAILED DESCRIPTION

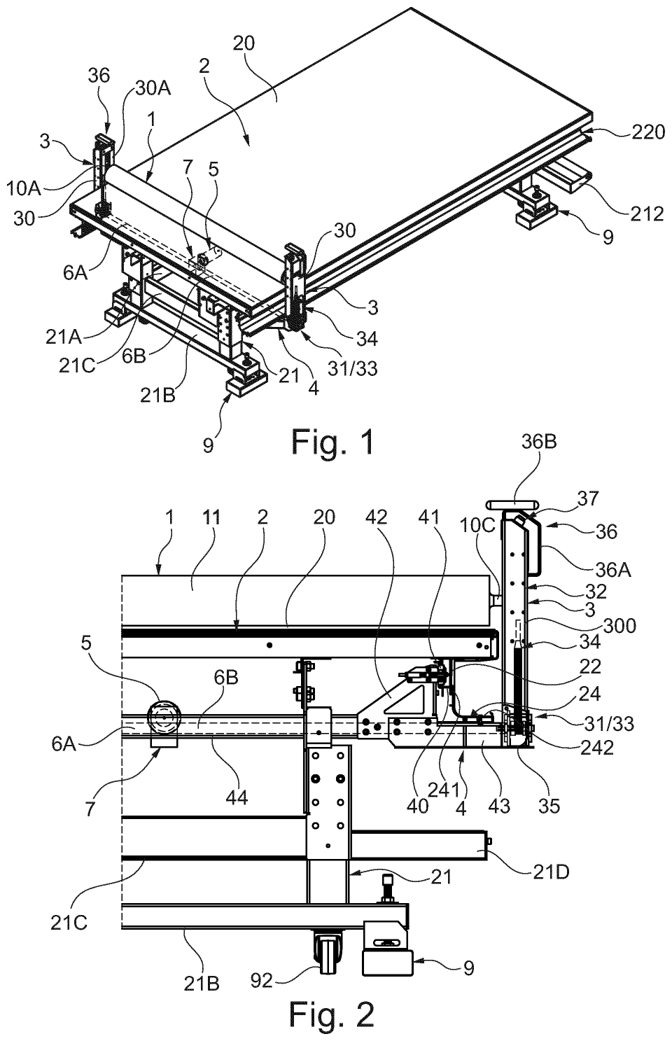

In FIGS. 1 and 2 there is shown a side view and a perspective view of an arrangement according to the invention of a first embodiment. There is shown schematically a flatbed applicator table 2 being supported by a leg arrangement 21, preferably having adjustable feet 9 (preferably remotely as will be explained more in detail below) and wheels 92 attached at the bottom of the leg arrangement 21, that may be used to move the whole flatbed applicator when the feet 9 are retracted above the level of the wheels 92.

The leg arrangement 21 includes longitudinal 21A and transversal support beams 21B, 21C. Further a roll holder 21D, for an extra roll may be attached to the leg arrangement 21. Two longitudinal supporting beams 22 are attached underneath the table 2 adjacent each longitudinal side of the table 2. On to, preferably at the inside of, the longitudinal supporting beams 22 there are arranged two fixed parallel profiles 40 providing a fixed support for linear, horizontal movement of guide members 41 for a support structure 4 carrying post members 3. Further, the longitudinal supporting beams 22 carry longitudinal shelf members 24, which are L-shaped having one of the legs 241 extending in a vertical direction, which leg 241 is fitted to the longitudinal supporting beams 22 and a horizontal leg member 242 extending towards the long side edge of the table 2 in a horizontal plane. The fixed parallel profiles 40 preferably have a C-shape, wherein the openings of the two fixed parallel profiles 40 are positioned facing each other. On each side there is preferably arranged a longitudinally distanced, pair of guide units, wherein each guide unit comprises two horizontally off set guide members 41, arranged to enable an adjustable clamping pressure within said fixed parallel profiles 40. Further, preferably the profiles are made of aluminum, e.g. extruded, having relatively soft surfaces, which may easily wear.

To minimize wear the profiles 40 may be arranged with a thin, high strength steel band 401, less than 1 mm thick, preferably between 0.7-0.3 mm thick, along the inner surfaces against which the wheels of the guide members 41 run. Most preferred the profiles are arranged with small longitudinal ridges creating longitudinal parallel grooves (not shown) into which each thin steel band 401 may be easily pushed for exact and easy positioning thereof. To arrange for fixing of the thin steel band 401 once in the groove it is merely needed to clamp/squeeze the ridges at the ends to safely maintain them in place. As is evident this feature may be used in different kind of flatbed applicators, i.e. to minimize wear and to provide an easy and cost-effective design for obtaining that. It is therefore foreseen that a divisional application may be filed protecting this feature without limitations to the preferred design defined in claim 1.

On each side of the table 2 there is accordingly one such post member 3, which thanks to the support structure 4 and the horizontal guiding structure 40/41 is linearly, horizontally moveable along the table 2. Within each post member 3, there is arranged a vertically moveable support structure 34. Each vertically moveable support structure 34 supports one end 10A, 10C of a shaft 10 that carries a roll 1. A motor 5 is arranged under the table 2, which via two shafts 6A, 6B (or alternatively one integral shaft) drives the vertically moveable support structure 34 for vertical displacement of the roll 1.

A mechanical arrangement 31, 33 transmits the torque from the shafts 6A, 6B to each vertically moveable support structure 34. The roll 1 has an outer surface 11 intended to be in contact with an object (not shown) positioned on the upper surface 20 of the table 2 in connection with performing lamination.

Each post 3 has a vertical guiding arrangement 30, preferably in the form of or supported by a housing 300 that extends vertically upwardly along the posts 3, e.g. including a vertically extending slot 30A for through passage of the shaft ends 10A, 10C into the interior of the post members 3, thereby enabling vertical movement in relation to the table 2 and housings 300.

Further FIGS. 1 and 2 shows that the upper end of each post 3 there are arranged handle means 36, to provide for easy movement of the roll 1 along the table 2. In a preferred embodiment there are multiple handles, e.g. a first handle 36A providing a vertically extending gripable part and one second handle member 36B providing a horizontally gripable part. In the preferred embodiment at least one activation device 37 is positioned nearby the handle device 36, to provide for easy activation of the motor 5, via a control unit (not shown) to either lift or lower the roll 1.

In FIG. 2 it is shown in detail that the support structure 4 includes a plurality of parts, that preferably are releasably attached to each other by means of screw/nuts. Centrally there is one central part 44 that carries the motor 5 and also the gear reduction device 7. The central part preferably is in a form of a longish U-formed metal plate member having a substantial width to match the total length of the motor and the reduction gear device 7. The leg portions of the U-formed part are directed upwardly and sufficiently high to provide for appropriate strength and for attachment of further parts of the support structure 4. The second part 42 of the support structure has as its main purpose to carry the guide members 41 that run within the fixed parallel profiles 40 attached to a support beam 22 underneath the table 2. These guide members 41 are in a form of a plurality of low friction wheel members, as is known per se. The third part 43 forms the intermediate attachment between the central part 44 and the bottom part 35 of each post 3. This part 43 also serves as support for the mechanical arrangement 31, 33 that provides for the vertical movement of the roll 1.

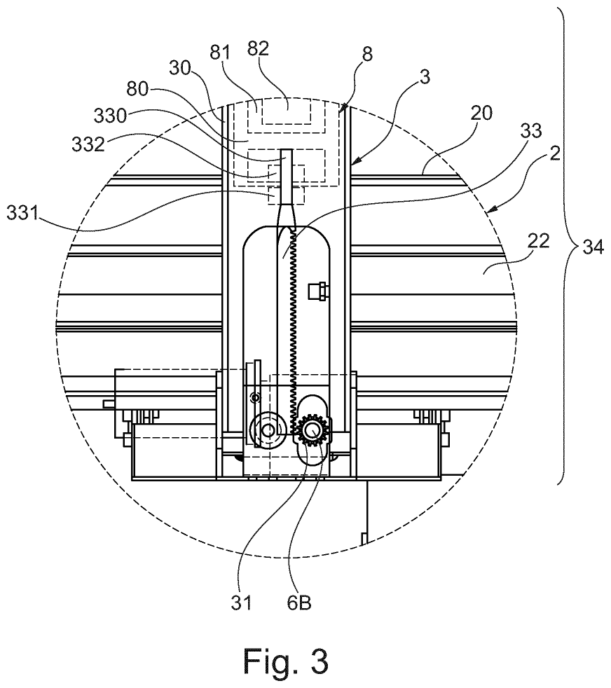

In FIG. 3 it is shown that the mechanical arrangement 31, 33, for vertical movement, may be in the form of splines 31 (alt. separate dented wheel), i.e. a pinion coaxial with the shaft axis, interacting with a vertically extending dented rod 33, i.e. rack, that forms the lower part of each vertically moveable support structure 34. A support and guide wheel 310 provides for rigidity of the arrangement. The upper part of each vertically moveable support structure 34 is formed by a resilient arrangement 8.

The resilient arrangement 8 is mechanically connected to the dented rod 33 and as a consequence connects each shaft end 10A, 10C with a dented rod 33. A control unit (not shown) provides for controlled activation of the shafts 6A, 6B via an activation device 37, (e.g. a touch pad) which in turn activates the mechanical arrangement 31, 33, causing lowering or lifting of the vertically moveable support structure 34.

From the output shaft 50 of the motor there is a reduction gear mechanism 7, preferably a worm gear, that reduces the rpm of the motor, in the range of 1/30-1/100, preferably 1/40-1/60. The shafts 6A, 6B (or alternatively one integral shaft) preferably are hollow shafts, to provide reduced weight and also suitable diameter d, e.g. 20-30 mm, for the splines 31. The splines 31 preferably have an outer diameter D of about 25-30 mm and a pitch of about 4-6 mm The splines 31 may either be integral with the shaft 6A, 6B or in the form of a bushing fixed to the end of each shaft 6A, 6B.

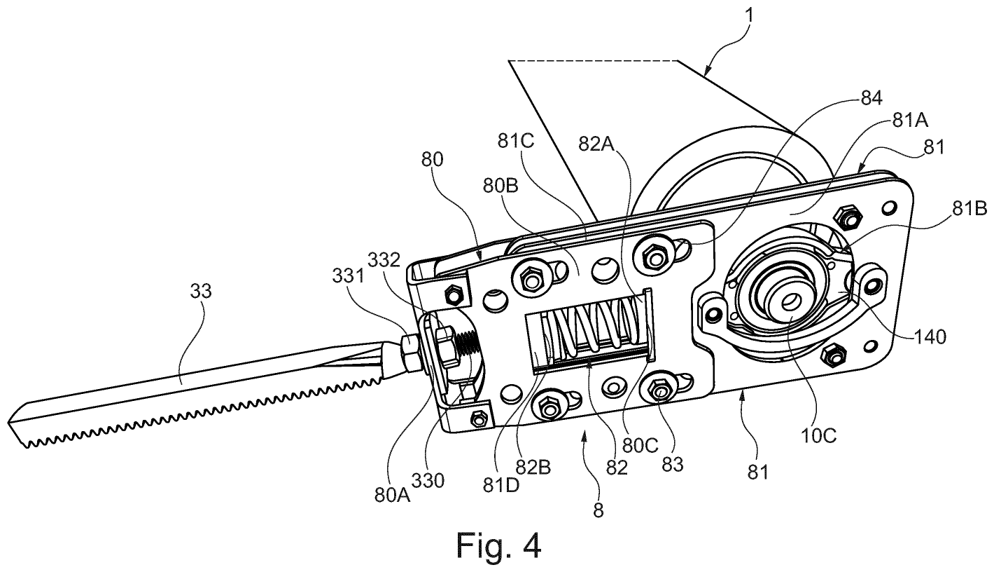

As shown in more detail in FIG. 4 each resilient arrangement 8 comprises a support member 80, a roll member 81 and a resilient member 82 in between them. The rack member 80 is, preferably adjustably, attached to the upper end part 330 of the dented rod 33. The upper end part 330 preferably is in the form of a threaded rod enabling adjustable fixation of the support part 80 by means of nuts 331,332 fixing a lower part 80A of the support member 80. The support member 80 has upwardly protruding wall parts 80B that protrude past the resilient member 82 and at the top a top part 80C forming an upper stop for the upper end 82A of the resilient member 82. The roll member 81 has an upper part 81A comprising a roll attachment 81B for fixation of each roll shaft end 10A, 10C. Downwardly protruding wall parts 81C protrude past the resilient member 82 and at the bottom a bottom part 81D forming a lower stop for the lower end 82B of the resilient member 82. Transversal guide members 83 interacting with vertical slits 84 safeguard a substantially rectilinear vertical movement relative to each other of the support member 80 and the roll member 81.

The resilient member 82 is positioned between the two stop parts 80C, 81D in pretensioned manner to urge the support member 80 and the roll member 81 to be positioned at a maximum distance apart in an unaffected mode. Preferably the tension is adjustable, e.g. by adjustment of the nuts 331,332 described above.

When the motor 5 is activated to lower the roll arrangement 1 the resilient arrangement 8 will be activated once the roll 2 gets into contact with the table 2, or an object on the table 2. The roll 1 will then transfer the load (due to contact) via its shaft ends 10A, 10C to the roll member 81, and thereby also to the lower end 82B of the resilient member 82, which will cause compression of the resilient member 82. Hence a resilient force/-pressure will be applied by means of the roll 1 onto the object/table 2. Preferably the resilient member 82 has a spring constant of about 500-1500 N, more preferred 600-1200 N.

The rubber material in the outer layer 11 preferably is arranged with a rubber composition in the range 40-55 shore A, which has proven to provide a high quality of the laminated products.

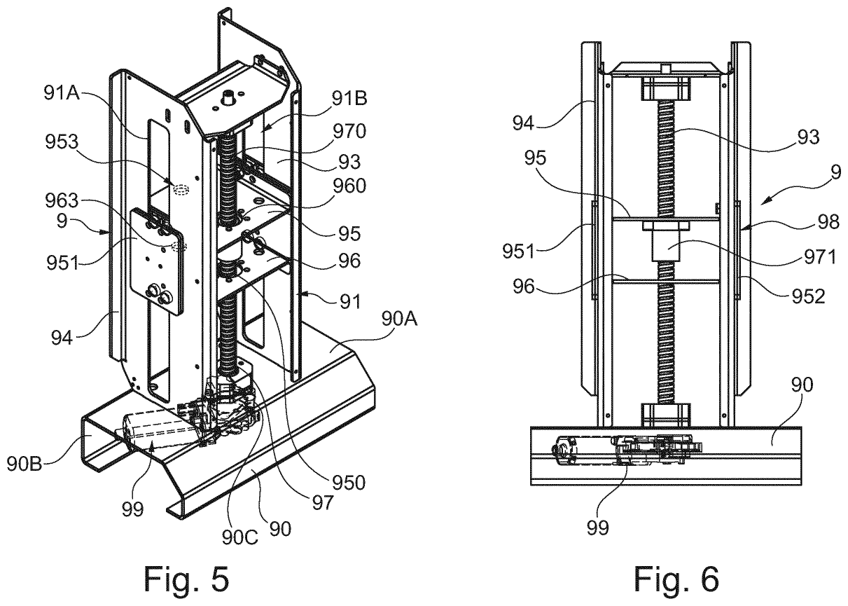

In FIGS. 5 and 6 there are shown two views of adjustable feet 9 that may be attached to the leg arrangement 21 of a flatbed applicator, preferably to a transversal feet beam 21B, 21C. As is evident it may be used in many different flatbed applicators, e.g. by use of adaptors and it is therefore foreseen that one or more divisional applications may be filed protecting the adjustable feet 9 as such. With reference to the flat bed applicator shown in FIGS. 1 and 2 the feet 9 are used as replacement for the traditional feet shown in FIGS. 1 and 2. The feet 9 comprise a bottom portion 90 that forms the support against a floor and a vertical support structure 91, that is movable in the vertical in relation to an attachment member 95 enabling attachment of the part of leg arrangement 21 that is fixed in relation to the table 2. Hence, it provides a kind of telescopic function between the feet 90 and the table 2. In the shown embodiment the vertical support structure 91 is basically in the form of two parallel vertical plates 93, 94. Two horizontal support plates 95, 96 are arranged in-between the two vertical parallel plates 93, 94. Substantially centrally within these plates there are coaxial through holes 950, 960. A linear actuator 97 is arranged coaxially within the vertical member 91 and has its threaded part 970 protruding coaxially through each one of said holes 950, 960. A linear actuator nut 971 is arranged to move the plates 95, 96 up and down, depending on rotation of the screw 970. The horizontal plates 95, 96 are connected by means of vertical side plates 951, 952, which side plates provide attachment of the leg arrangement 21 and also keep the two plates 95, 96 at a constant distance.

Further guide members, preferably in the form of screws connecting the side plates 951, 952 with the horizontal plates 95, 96, are arranged to be movable within a vertical slit 91A, 91B that is arranged substantially in the middle in in each one of the vertical plates 93, 94. A motor and reduction gear 99 provides rotation of the screw 97, such that a motorized adjustment of the height of the plates 95, 96 may be achieved. Attachment holes 953, 963 are arranged to fixedly attach a leg arrangement 21 of a flatbed applicator. In the embodiment shown in FIGS. 1 and 2 it is the ends of the transversal leg beams 210 that will be attached by means of said through holes 953, 963, matching corresponding through holes adjacent each end of the transversal leg beams 210. By the use of a joint control unit (not shown) all motors 99 may be activated simultaneously to easily adjust the height of table 2.

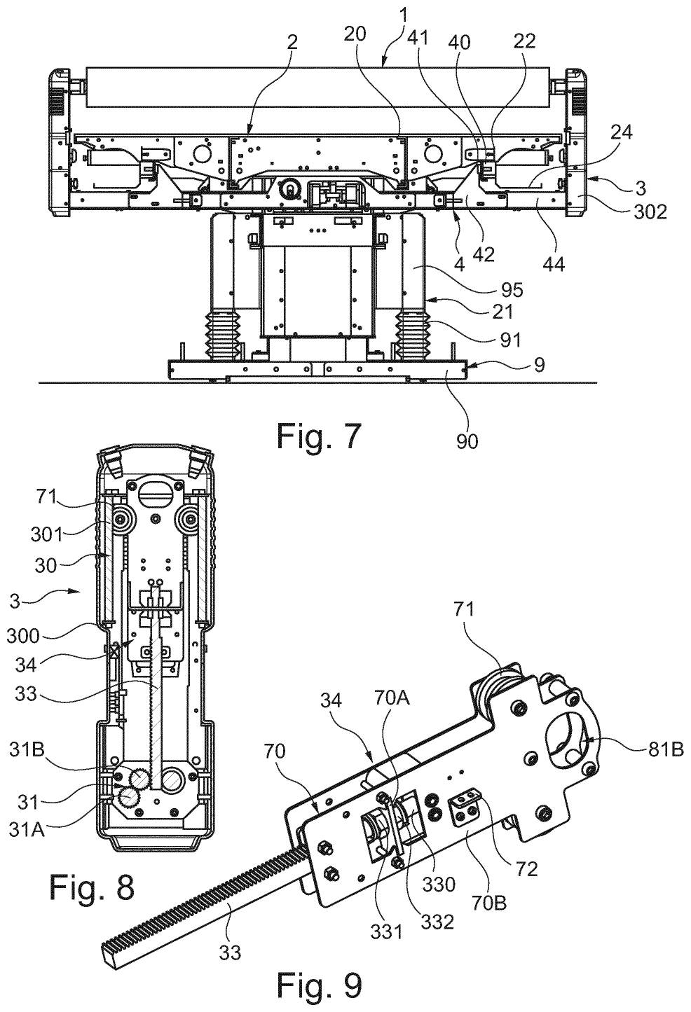

In FIG. 7 there is shown a transversal cross-sectional view of a modified embodiment of a flatbed applicator according to a preferred embodiment of the invention, wherein basic features and functions are the same as described above and indicated by the use of the same reference numbers. Accordingly, merely different aspects will be focused in the following. Also, here the support structure 4 includes a plurality of parts, that preferably are releasably attached to each other by means of screw/nuts. A central part 44, in the form of a U-beam carries the motor 5, the gear reduction device 7 and also a second part 42 of the support structure carrying the guide members 41 that run within the fixed parallel profiles 40 attached to the support beam 22 underneath the table 2. These guide members 41 are in a form of a plurality of low friction wheel members, as is known per se. The central part 44 forms the intermediate attachment between each post 3.

The feet 9 comprise a bottom portion 90 that forms the support against the floor. There is a vertical support structure 91, that is telescopically movable in the vertical in relation to an attachment member 95 of leg arrangement 21 that in turn is fixed in relation to the table 2. Hence, it provides a telescopic function between the feet 90 and the table 2. Preferably wheels 92 (see FIG. 11) are attached at the bottom of the leg arrangement 21, that may be used to move the whole flatbed applicator when the feet 9 are retracted above the level of the feet 9.

According to the preferred embodiment of the invention as shown in FIGS. 8 and 9 the vertically moveable support structures 34 are rigid, i.e. do not include any resilient device, e.g. no springs that assist to keep a desired pressure between the roll 1 and the surface that is pressurised by means of the roll 1. Further, the mechanical arrangement 31, 33, for vertical movement, is in the form of a pair of dented wheels 31A, 31B wherein the first wheel 31A is coaxial with and driven by the shaft 6 and transfers rotation to the second wheel 31B that interacts with the vertically extending dented rod 33. Having two wheels 31A, 31B provides the advantage that further flexibility is achieved. Firstly, it provides the possibility to position intermediate wheel 31B at a higher level than the driving wheel 31A, such that the dented wheel may protrude less below the post 3. Further it provides the possibility to position the driving wheel 31A more off centered, e.g. such that a more appropriate positioning of the motor 5 is achieved and also that flexibility regarding gear ratio is achieved.

The basic design and function (for vertical movement) is the same as shown in and described in relation to FIG. 4. Therefore, the same ref. signs have been used for identical parts and ref. signs (see FIG. 9) for similar items have been given identical suffix but in a 70 series, e.g. sidewalls 70B and 80B respectively. A rigid support member 70, comprising two attached walls 80B, is mechanically connected to the dented rod 33. Adjacent the upper end of the support member 70 there is provided a roll attachment 81B for fixation of each roll shaft ends 10A, 10C. The support member 70 is, preferably adjustably, attached to the upper end part 330 of the dented rod 33, preferably by means of nuts 331, 332 clamping an upper part of the dented rod 33 to a lower part 70A fixated within the support member 70. Preferably a pair of guiding wheels 71 are rotatably attached to the support member 70, providing a low friction guidance of the vertically moveable support structures 34 within the housing 3. Here it is shown that the guiding arrangement 30 comprises a pair of rods 301 that are attached vertically within the housing 300 and interacting with the pair of guiding wheels 71. Further an attachment 72 may be provided for attaching different parts.

The desired pressure is achieved by means of controlling the current level of the power supplied to the motor 5. As is well known a motor is in need of a higher current level if a higher amount of torque is to be applied. As a consequence, it is possible to use the measured power level in real time do determine the pressure applied by means of the roll. Since the transmission facilitating the vertical movement of the roll is totally synchronised this provides for a possibility to apply an exactly desired pressure to the surface 20, which of course requires precision regarding the parallelity between the top surface 20 of the table 2 and the periphery of the roll 1. Once adjusted and/or calibrated to be sufficiently parallel the totally synchronised transmission may provide for distribution of uniform pressure along the whole width of the roll 1.

Furthermore, this facilitates flexibility to provide for different pressures that may be preinstalled in a software or hardware that is controlling the supply of current to the motor 5. In the preferred embodiment the software is prepared to have a plurality of different desired pressures that may be applied by means of the roll 1. Most preferred the control may be achieved by means of a wireless device, e.g. infrared remote, having a desired plurality of pre-set operating pressure levels. A further benefit of using the current of the motor to (or indeed the voltage, since p=u*i) to control it, is that end stop censors may be eliminated, since basically the same function may be used to arrange for an automatic stop of the motor when reaching its upper end position. Hence, when the shaft of the roll 1 reaches its end position in the guide path 30A it will get in contact with the end of said guide path 30A and thereby an increase of the current level in the motor will occur. Preferably the control circuit then will lower the shaft a small distance to avoid undesired tensions at the end position.

Thanks to the precision that the inventive concept may provide regarding pressure, temperature, and speed it is foreseen that the control of the lamination process may be precisely controlled in accordance with pre-set requirements for a variety of different laminations processes and products. As is well known most manufacturers provide an optimal temperature, an optimal pressure, and optimal lamination speed to achieve the highest quality of the lamination. With the inventive concepts in combination with a control arrangement (e.g. software and appropriate electronic devices) the control unit operated by the operator may be pre-programmed to push a certain button (or provide a command in any other appropriate manner) to thereby initiate a lamination process that will deliver pressure, temperature, and lamination speed in accordance with the recommended levels provided by the manufacturer. As a consequence, reliable production for producing high quality laminations may easily be provided.

An algorithm may be used to supply sufficient heat during the lamination process, by applying adapted amount of power to compensate for cooling during the travel of the roll along the laminating table, preferably thereby adapting in relation to a plurality of parameters sensed by appropriate sensors. In order to eliminate the needs of extra heat supply during the lamination process the roll may be designed to contain sufficiently large amount of heat, e.g. by means of relatively thick metal sleeve, such that the cooling during the laminating process may be neglectable. Of course, this is depended on the amount of heat that is absorbed by the product that is to be laminated, which is turn may be minimised by pre-heating the product. An example of sensors that may be used to control the process may be IR sensors.

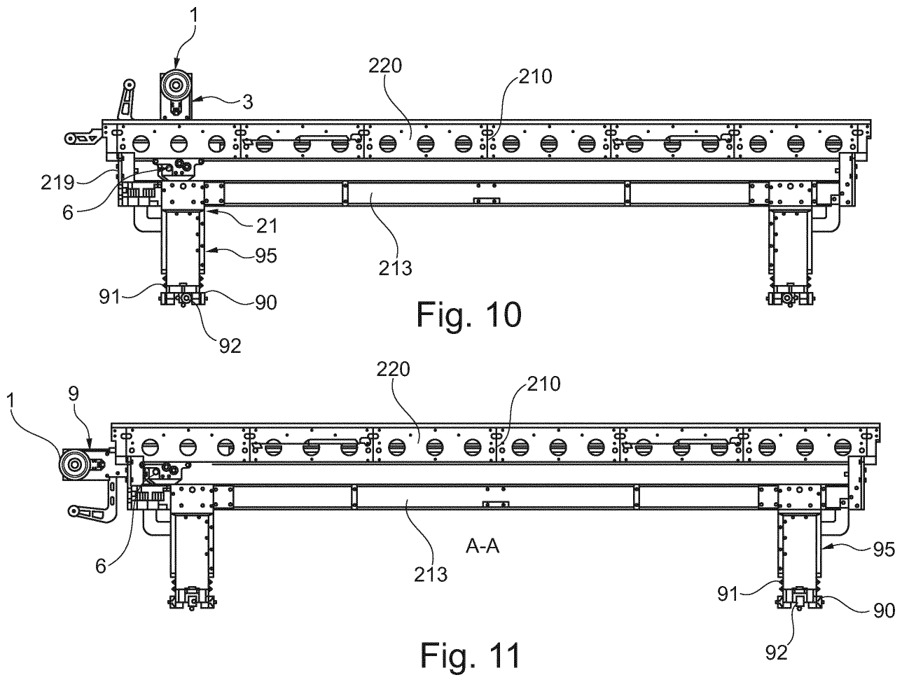

In FIGS. 10 and 11 there are shown longitudinal cross-sectional views of the modified embodiment of a flatbed applicator according to the preferred embodiment of the invention, wherein the post 3 is in a vertical active position in FIG. 10 and the post 3 is in a pivoted horizontal non-active position in FIG. 11. Hence, the post members 3 together with the roll 1 maybe be pivoted around an axis that is coaxial with the axis of the drive shaft/s 6 of for the vertically movable member 34. Bearings 302 (indicated in FIG. 7) are arranged fixed to the housing 300 providing the possibility to pivot the post together with the roll 2, 90 degrees between an upright vertical position, as shown in FIG. 10, and a horizontal position, as shown in FIG. 11. Thanks to this design option many advantages may be obtained. It provides the possibility of pivoting the post 3 and the roll 2 to have the whole table 2 as a working surface without any influence of the roll or the posts. A further evident advantage is that in the horizontal position when the roll 2 is positioned along a short end side on the table 2 a much more compact unit may be achieved, e.g. in connection with transport. The figures also show that there are arranged two intermediate lateral supports 219 adjacent each short end, which may provide rigid support between the frame structure 200 of the table and the leg arrangement 21.

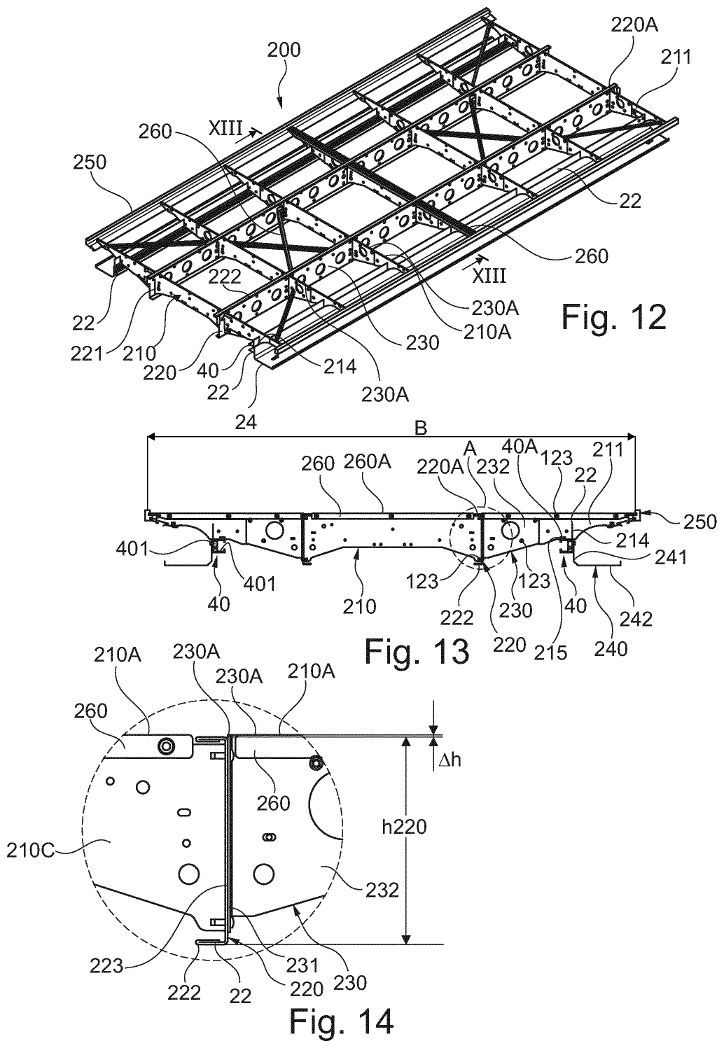

In FIG. 12 there is shown a perspective view from above of a preferred frame structure 200 for table 2 according to the invention. FIG. 13 is a transversal cross-sectional view of the preferred frame structure along V111-V111 in FIG. 12 and FIG. 14 is a detailed view of the encircled area in FIG. 13. The purpose of the preferred frame structure 200 includes a plurality of aspects, e.g. it may provide a less heavy design than conventional frame structures, it may provide a less costly design thanks to use of less material, and it may provide a more precise support surface for the applicator table 2.

The frame structure 200 is built up by the use of a plurality, of identical frame parts 210, 220, 230, 22, 250. There are two inner longitude frame parts 220, a large plurality of transversal frame parts 210, a large plurality of U-shaped frame parts 230, two outer longitudinal frame parts 22, two outer most longitudinal frame parts 250 and a plurality of supporting crossbars 260. Most of the frame parts 210, 220, 230, 24 are made from thin plate metal sheets, e.g. having a thickness of 1 to 4 mm, preferably around 2 mm, taking advantage of the fact that the height h of a supporting frame part has a much higher influence on strength and rigidity regarding bending compared to the thickness t of the material, i.e. since flexural rigidity is proportional to h3. Hence all of the members are designed to have a height h (in the vertical direction when the table 2 is positioned horizontally) that is many times larger than the thickness t of the material. Thanks to this principal much less material is needed to provide a reliable and rigid support for the table 2 than is needed according to traditional design using a more rigid beam construction.

A further advantage with use of thin sheet material is that supporting surfaces may easily be exactly cut by established cost-effective methods that can provide very good planarity (e.g. a planarity of 0.2 mm or less), e.g. laser cutting or nibbling. This fact is used by having precisely cut upper support surfaces 210A, 230A of the frame parts 210, 230 that include cross-wise positioned support surfaces 210A, 230A that provide for the main support of the table 2. Further thin sheet material also provides for use of established cost-effective methods to achieve exact positioning of through holes in frame members that need to be exactly attached to each other. By use of exactly positioned through holes (e.g. laser cutting or punching) and exactly fitting thread shaping screws an exact interfit between the different frame parts may easily be achieved.

The transversal frame members 210 are one of the members arranged with a laser cut upper support surface 210A. Accordingly, these transversal frame members 210 provide support surfaces 210A in transversal direction of the table 2. Longitudinal support is mainly provided by the upper surfaces 230 A of the U-shaped frame members 230. In the preferred embodiment the inner longitudinal frame members 220 provide for a major portion of the strength of the frame 200, which partly is achieved by arranging these parts 220 having a large height h220 and partly by arranging them 220 with flanges 222. Thanks to having the largest height of the frame at an inner position there is arranged for more space (leg space) under the table 2 near the long sides of the table 2, which is a significant advantage. Preferably each longitudinal frame member 220 extend the whole length L of the table 2 but does not assist in providing support surface for the table 2. Therefore, preferably the upper surface 220A of the inner longitudinal frame member 220 is positioned a distance Δh below the actual support surfaces 210 A, 230A. The reason for this is that the inner longitudinal frame members 220 preferably shall also provide strength and rigidity in the transversal direction. This is achieved by arranging perpendicular flanges 222 in relation to the extension on the main plane of the longitudinal inner frame members 220, by means of folding (preferably folded twice or more) the longitudinal edges of the inner longitudinal frame members 220. As is well understood by the skilled person in the art it is much more complicated and costly to arrange for exact positioning of an upper surface 220A belonging to folded parts of a sheet material than the use of exactly laser cut sheet material.

Accordingly, this is the reason why the upper surface 220A of the inner longitudinal frame members 220 preferably are positioned at a lower level than the table support plane that includes the actual support surfaces 210A, 230A for the table 2. As already mentioned above, preferably the frame members are joined to each other by means of exactly fitting thread shaping screws 123 (i.e. screws having a diameter larger than the holes) joining the different frame members by use of the exactly positioned, exactly fitting holes in the different sheet members. As is well known welding may cause displacement of parts due to the heat influence during the welding process.

Accordingly, the use of exactly fitting holes and exactly fitting screws is a safer principle to achieve exact positioning of a plurality of attached members. Preferably the transversal members 210 extend the whole width B of the table. Therefore, the inner longitudinal frame members 220 are provided with passages 221 adapted for housing the transversal frame members 210. Hence, the maximum height h210A of the through passing parts 213 of the transversal frame members 210 basically corresponds to the height h221 of the passages 221. Furthermore, each transversal frame member 210 is arranged with a main recess 211 including an attachment surface 211A for positioning of the main body 220A of the longitudinal frame members 220 and an additional side recess 212 that facilitates the positioning of the upper surface 210A of the transversal frame members 210 at a level above the upper surface 220A of the inner longitudinal frame members 220.

The U-shaped frame members 230 are arranged with a midsection 231 that is attached in parallel to the inner longitudinal frame members 220 at an opposite side of the longitudinal frame members compared to the flanges 222. Also, here the upper surface 230 A of the U-shaped frame members 230 are positioned at level above the upper surface 220A of the inner longitudinal frame members 220. The leg members 232 of the U-shaped frame member 230 are positioned with their upper surface 230A in exact level with the upper surface 210A of the transversal frame members 210 and connected by screws 123 with the transversal frame members 210. Accordingly, this design provides for a very exact support surface for the table 2 having crosswise extending upper laser cut edges 210A, 230A of interconnected frame members.

There are also two longitudinally extending outer most frame members 250 that provides rigidity and strength along the long sides of the table 2 and that also protects the outer edges of the table 2.

The transparent table member (working surface) may comprise one or two glass sheets. According to a preferred embodiment (not shown) the transparent table member comprises three layers, a bottom layer of a transparent supporting polymer (e.g. 2 mm), an intermediate layer of glass (e.g. 6 mm) and a top layer of durable transparent polymer (e.g. 4 mm). Sometimes there is a desire to not have the transparent table member in single piece, but having it divided into two pieces, e.g. to provide for more easy transport of the parts. In such a case it is an advantage to provide for extra support transversally where the edges of the transparent table member parts meet. In the figure it is showing that this support is arranged by means of two L-shaped supports 260 attached on each side of a transversally extending frame member 210. The upper surface 260 A of one of the legs in these L-shaped supports are positioned at exactly the same level as the other supports surfaces 210 A, 230A. Thanks to thereby providing a relatively wide support surface by means of these L-shaped supports 260 the meeting edges of different layers in the table may be positioned off set in relation to each other, which provides the advantage that the different layers will then assist each other in extending in a desired plane also in that area.

Further it is shown that there are two outer longitudinal frame members 22 which are connected basically centrally on the outer parts 210D of transversal frame members 210, by means of slots 214 that extend vertically. These frame members 22 carry the guiding profiles 40. Further, the outer longitudinal frame members 22 carry the longitudinal shelf members 24. The guiding profile 40 is arranged with a longitudinal ridge 40A and the transversal frame members 210 is arranged with a recess 215 adapted to provide exact fit for that longitudinal ridge 40A.

Finally, it is shown that crossbars 260 are being used to enforce the design, wherein two crossbars 260 are positioned in a cross extending between the two inner longitudinal frame members 220 and further crossbars 261 are positioned extending between an outer end of an outer most, transversal frame member 210 and one longitudinally extending inner frame member 220.

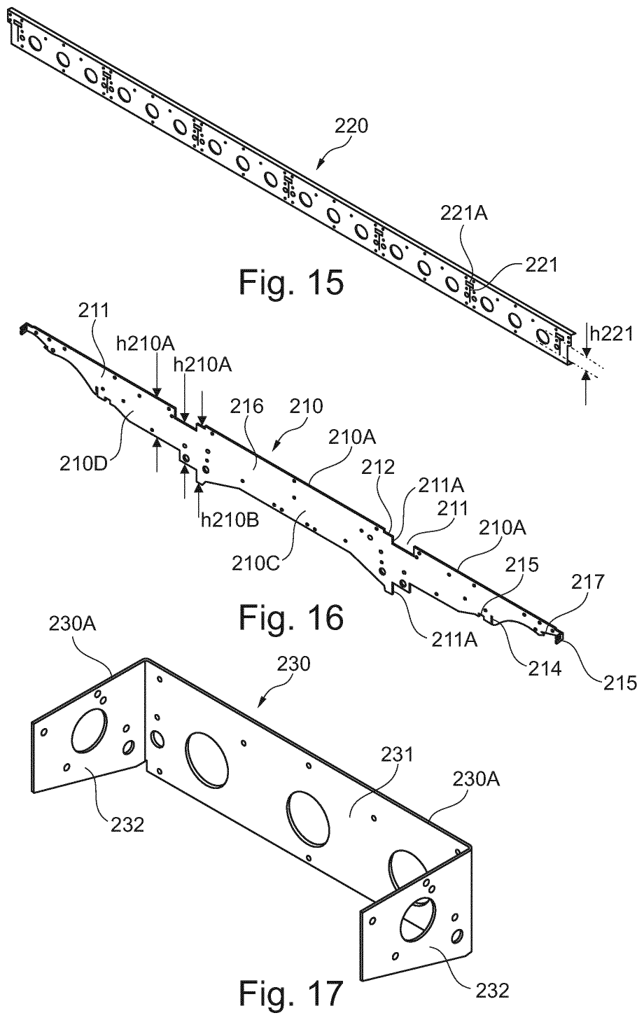

In FIG. 15 there is shown a perspective view of a longitudinal frame member 220 of the preferred frame structure 200. As shown, the inner longitudinal frame members 220 are provided with passages 221 adapted for housing the transversal frame members 210. At the upper ends of these passages 221 there is preferably arranged an enlarged hole 221A that may provide space for protruding parts (e.g. end connectors 218) of the transversal frame members 210.

In FIG. 16 there is shown a perspective view of a transversal frame member 210 of the preferred frame structure 200. To fit through the passages 221 of the inner longitudinal frame members 220 the maximum height h210A of the through passing parts 210D of the transversal frame members 210 basically corresponds to the height h221 of the passages 221. Furthermore, each transversal frame member 210 is arranged with a main recess 211 including an attachment surface 211A for positioning of the main body 223 of the longitudinal frame members 220 and an additional upper side recess 212 that facilitates the positioning of the upper surface 220A, including the flanges 222, of the inner longitudinal frame members 210 at a level Δh below the upper surface 210A of the transversal frame members 210. The maximum height h210B of the central part 210C is substantially larger than the maximum height h210A of the outer parts 210D of the transversal frame members 210. Further, there are at the ends of the transversal frame members 210 recesses 217 and attachment devices 218 for attachment of the outer most longitudinal frame members 250.

FIG. 17 is a perspective view of a third frame member 230 of the preferred frame structure. The U-shaped frame members 230 are arranged with a midsection 231 intended for attachment in parallel to the inner longitudinal frame members 220 at an opposite side of the longitudinal frame members compared to the flanges 222. Also, here the upper surface 230 A of the U-shaped frame members 230 are positioned at level above the upper surface 220A of the inner longitudinal frame members 220. The leg members 232 of the U-shaped frame member 230 are positioned with their upper surface 230A in exact level with the upper surface 210A of the transversal frame members 210 and bridging the recesses 211, 212 of the transversal frame members 210.

As is evident the novel frame structure 200 may be used in different kind of flatbed applicators. It is therefore foreseen that one or more divisional applications may be filed protecting essential feature of the frame structure 200 as such, without limitations to the preferred design defined in claim 1.

For instance, one main claim for that novel structure could read, a flatbed applicator, comprising a table (2) and a roll (1) movably guided vertically and horizontally along the table (2) by means of post members (3), a horizontal guiding structure comprising fixed parallel profiles (40) attached to a table support structure (200) of the table (2) for guide members (41) fixedly attached to a support structure (4) carrying each of said post members (3), wherein said table support structure (200) is in the form of a framework comprising a plurality of longitudinally arranged frame members (22, 220, 250) or frame parts (231) interconnected with a plurality of transversally arranged frame members (210) or frame parts (232) providing support surface (210A, 230A), wherein said frame members are made from thin metal sheet and each frame member has a height (h) that is at least 10 times the thickness (t) of said metal sheet and at least a substantial portion of, preferably all of, said support surface (210A, 230A) is in the form of upper cut edges of said thin metal sheet.

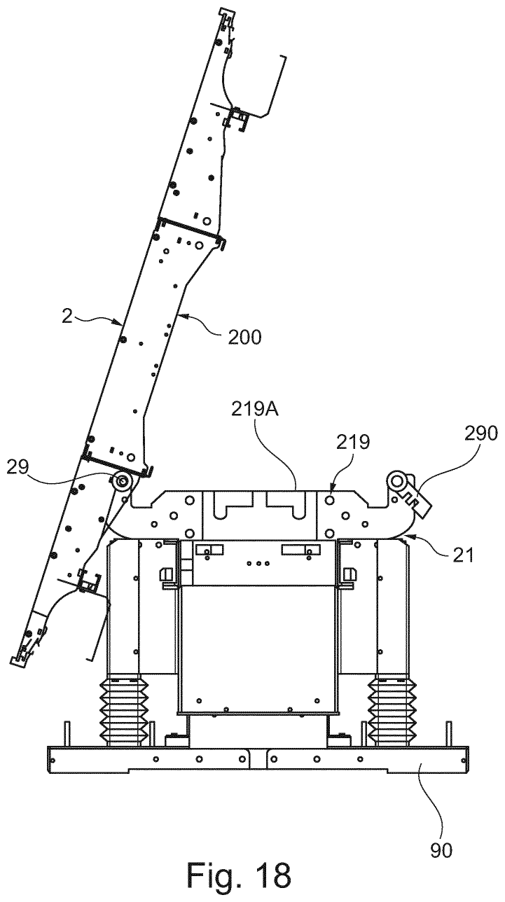

FIG. 18 is a side view of an additional design feature of a flatbed applicator according to a preferred embodiment of the invention, wherein the table 2 is pivotally arranged in an intermediate lateral support 219 arranged at the top of the leg arrangement 21 and has been pivoted to a substantially vertical position. Accordingly, the attachment of the table 2 to the leg arrangement 21 may also be arranged pivotally about a horizontally arranged pivot shaft 29. Preferably it may be adjustably pivoted by means of an adjustable counter support 290 that provides for different levels for support of the table at the opposite side in relation to the pivot shaft 29, e.g. to provide for a working surface that is arranged at an angle in relation to the horizontal, basically as is well known in connection with the working tables for designers. When also the table can be pivoted from a horizontal position to vertical position an even more compact arrangement may be achieved, especially if, according to preferred embodiment, the transversally protruding feet members 90 may be dismounted on the opposite side in relation to the position of the vertically pivoted table 2. When laminating the upper surface 219A of the intermediate lateral support 219 provides a rigid support for the table 2.

As is evident this feature may be used in different kind of flatbed applicators, i.e. to minimize space requirement and/or to provide an optimized working angle. It is therefore foreseen that a divisional application may be filed protecting this feature without limitations to the preferred design defined in claim 1.

Thanks to the arrangement according to the invention numerous advantages may be achieved. The invention may be modified in many ways in relation to what is shown in figures without departing from the basic concept of the invention. For instance, it is foreseen that a different kind of motor than electric (e.g. hydraulic) may be used and that the motor for the roll height adjustment may be positioned differently, i.e. close to one side instead of the middle, and that more than one motor may be connected to provide the desired torque. Further, the skilled person realizes that different kinds of reduction gears may be used, e.g. a planetary gear, and also that that different kinds of mechanical transmission may be used, e.g. linear actuator mechanism driven by a worm gear by the shaft/s 6. Further, the skilled person realizes that different devices may be used to provide the resilient function, e.g. a rubber member or a blade spring, etc in place of a helical spring. Moreover, it is foreseen that many of the basic aspects of the invention may be fulfilled without any resiliency at all, i.e. a stiff connection of the roll to the vertically movable structure.

1. A flatbed applicator, comprising a table (2) and a roll (1) movably guided vertically and horizontally along the table (2) supported by a leg arrangement (21) by means of post members (3), a horizontal guiding structure comprising fixed parallel profiles (40) attached to the table (2) and guide members (41) fixedly attached to a support structure (4) carrying each of said post members (3),
each of said post members (3) including a vertically moveable support structure (34) carrying said roll (1) and a vertical guiding arrangement (30) arranged to guide said vertically moveable support structure (34),
a power unit (5) and transmission (6A, 6B, 7) arranged to enable vertical movement of said vertically moveable support structure (34),
said roll (1) comprising shaft ends (10A, 10C) that are connected to said vertically moveable support structure (34), characterized in that,
said power unit (5) is in the form of a motor (5), preferably electric motor, attached to said support structure (4) and arranged under said table (2), wherein said transmission (6A, 6B, 7) is in the form of a single reduction gear mechanism (7) and that said single reduction gear mechanism (7) is arranged to synchronously transmit torque to one, or a pair of, drive shaft/s (6A, 6B), which via a mechanical transmission (31, 33) drives said vertically movable support structure (34).

2. A flatbed applicator according to claim 1, characterized in that said single reduction gear mechanism (7) has a reduction rate in the range of 1/30-1/100 and that said pinion (31) has an outer diameter (D) in the range of 20-35 mm, preferably 25-30 mm and a pitch in the range of 3-7 mm, preferably 4-6 mm.

3. A flatbed applicator according to claim 1, characterized in that said mechanical transmissions (31, 33) include a pinion (31) and a dented rod (33), wherein preferably said dented rod (33) has an upper part (330) attached, preferably adjustably, to a bottom part (80A) of a rack member (80) carrying said roll (1).

4. A flatbed applicator according to claim 1, characterized in that the pressure applied onto the table (2) by the roll (1) is controlled by the torque applied by said motor (5), preferably directly without any intermediate resilient members.

5. A flatbed applicator according to claim 1, characterized in that said vertically moveable support structure (34) includes a resilient arrangement (8) comprising a rack member (80), a roll member (81) and a resilient member (82) arranged to transfer load between said rack member (80) and said roll member (81).

6. A flatbed applicator according to claim 5, characterized in that said rack member (80) includes from said bottom part (80A) upwardly protruding wall parts (80B) that protrude past the resilient member (82) and at the top a top part (80C) forming an upper stop for an upper end (82A) of said resilient member (82), and that said roll member (81) includes an upper part (81A) comprising a roll attachment(81B) for fixation of said roll shaft end (10A, 10C) and downwardly protruding wall parts (81C) protruding past said resilient member (82) and at the bottom a bottom part (81D) forming a lower stop for the lower end (82B) of said resilient member (82), wherein said resilient arrangement (8) includes transversal guide members (83) interacting with vertical slits (84) arranged to safeguard a substantially rectilinear vertical movement relative to each other of said rack member (80) and said roll member (81), wherein preferably said vertical slits (84) define a limited range of relative movement between said rack member (80) and said roll member (81), and more preferred wherein said resilient member (82) is positioned between said two stop parts (80C, 81 D) in a pretensioned manner urging said rack member (80) and said roll member (81) to be positioned at a maximum distance apart in unloaded mode, wherein preferably said pretension is adjustable, more preferred by adjustment of the attachment point of said upper part (330) and said bottom part (80A) of said rack member (80).

7. A flatbed applicator according to claim 1, characterized in that the horizontal guiding structure (40/41) on each side is arranged with a pair of guide units, wherein each unit comprises two horizontally off set guide members (41), arranged to enable an adjustable clamping pressure within said fixed parallel profiles (40).

8. A flatbed applicator according to claim 1, characterized in that the horizontal guiding structure (40/41) includes at least one profile (40) arranged with at least one pair of longitudinal, parallel, facing ridges creating longitudinal parallel grooves for mounting of a thin steel band 401.

9. A flatbed applicator according to claim 1, characterized in that said posts (3) are pivotally arranged around an axis coaxial with said one, or pair of, drive shaft/s (6A, 6B), preferably by means of one or more bearings (302) attached to a housing (300) of said post (3).

10. A flatbed applicator according to claim 1, characterized in that said flatbed applicator table (2) is supported by a leg arrangement (21) having vertically adjustable feet (9), preferably remotely adjustable, and wheels 92 attached at the bottom of the leg arrangement 21 beside said vertically adjustable feet (9), preferably in between said vertically adjustable feet (9), arranged to enable said vertically adjustable feet (9) to be lifted above the level of the feet (92), wherein more preferred a motor and reduction gear (99) of a linear actuator (97) is arranged to move a vertically movable feet arrangement attachment device (95).

11. A flatbed applicator according to claim 1, characterized in that said profiles (40) are attached to a table support structure (200) of the table (2)
in the form of a framework comprising a plurality of longitudinally arranged frame members (22, 220, 250) or frame parts (231) interconnected with a plurality of transversally arranged frame members (210) or frame parts (232) providing support surface (210A, 230A), wherein said frame members are made from thin metal sheet and each frame member has a height (h) that is at least 10 times the thickness (t) of said metal sheet and at least a substantial portion of, preferably all of, said support surface (210A, 230A) is in the form of upper cut edges of said thin metal sheet, wherein preferably said at least one longitudinal frame member (220) has a height (h220) that is substantially larger than the height (h250) of the outer most longitudinal frame members (250), positioned adjacent the long side edges of the table (2).

12. A flatbed applicator according to claim 1, characterized in that said table (2) is pivotally arranged in an intermediate lateral support member (219) arranged at the top of the leg arrangement (21) about a horizontally arranged pivot shaft 29, wherein preferably the table (2) may be adjustably pivoted by means of an adjustable counter support (290) at the opposite side in relation to the position the pivot shaft (29).

13. A method for operating a flatbed applicator, said flatbed applicator comprising a table (2) supported by a leg arrangement (21) and a roll (1) movably guided vertically and horizontally along the table (2) by means of post members (3), a horizontal guiding structure comprising fixed parallel profiles (40) attached to the table (2) and guide members (41) fixedly attached to a support structure (4) carrying each of said post members (3),
each of said post members (3) including a vertically moveable support structure (34) and a vertical guiding arrangement (30) arranged to guide said vertically moveable support structure (34),
a power unit (5) and transmission (6A, 6B, 7) arranged to enable vertical movement of said vertically moveable support structure (34),
said roll (1) comprises shaft ends (10A, 10C) that are connected to said vertically moveable support structure (34), characterized by,
providing said power unit (5) is in the form of an electric motor attached to said support structure (4) and arranged under said table (2) and providing said transmission (6A, 6B, 7) is in the form of a single reduction gear mechanism (7) attached to said transversal support member (42) wherein said single reduction gear mechanism (7) synchronously transmits torque to one, or a pair of, drive shaft/s (6A, 6B), which via a mechanical transmission (31, 33) drives said vertically movable support structure (34).

14. A method for operating a flatbed applicator, according to claim 13, wherein said vertically moveable support structure (34) is controlled by a control unit whereby an adjustable pressure may be applied by the roll (1) on to the table (2) by means of controlling the torque of the motor (5). 15 (Currently Amended) A method for operating a flatbed applicator, according to claim 13, wherein said posts (3) may be pivoted around an axis coaxial with said one, or pair of, drive shaft/s (6A, 6B), between a vertical and horizontal position.
